(19) United States
(12) Patent Application Publication
(10) Pub. No.: US 2007/0098486 A1
(43) Pub. Date: May 3, 2007

(54) Paper binder

(75) Inventor: Chin-Lien Ho, Taichung City (TW)

Correspondence Address: CHARLES E. BAXLEY, ESQ., 90 JOHN STREET, THIRD FLOOR, NEW YORK, NY, 10038, US

(73) Assignee: Danny & Hudson Inc.

(21) Appl. No.: 11/264,531

(22) Filed: Oct. 31, 2005

(51) Int. Cl. B42F 13/00

(52) U.S. Cl. 402/73

(57) ABSTRACT

A paper binder includes a face cover, a back cover, a spine connected between the face cover and the back cover, a supplementary strip, which has a first side panel, a second side panel affixed to the back cover, a bottom panel hinged to the first side panel and the second side panel to hold the first side panel and the second side panel in parallel, and a plurality of flaps respectively hinged to the second side panel, and snaps each having a socket side respectively affixed to the first side panel and a stub side respectively affixed to the flaps and connectable to the socket side for holding papers.

### BACKGROUND OF THE INVENTION

1. Field of the Invention:

The present invention relates paper binders for holding sheet members together and more particularly, to a snap binder. 2. Description of the Related Art:

A conventional snap binder, as shown in FIG. 1, comprises a face cover 10, a back cover 11, a spine 14 connected between the face cover 10 and the back cover 11, a first hinge 12 joining the face cover 10 and the spine 14, a second hinge 13 joining the back cover 11 and the spine 14, a plurality of socket elements 15 respectively fastened to the face cover 10 at an inner side and aligned in a line along the first hinge 12, and a plurality of stud elements 16 respectively fastened to the back cover 11 at an inner side and aligned in a line along the second hinge 13 corresponding to the socket elements 15. According to this design, the face cover 10, the back cover 11, the socket elements 15 and the stud elements 16 made of plastics. Further, the face cover 10 and the back cove 11 are flexible.

When using the aforesaid snap binder, the snap binder is extended out as shown in FIG. 1, and then the punched sheet members P are arranged in a stack and put in the snap binder with the respective pun holes H respectively coupled to the stud elements 16, and then the face cover 10 is closed to force the socket elements 15 into engagement with the respective stub elements 16 as shown in FIG. 2.

When opening the snap binder, the user must carefully apply the force so as not to separate the stud elements 16 from the socket elements 15. When opening this snap binder, as shown in FIG. 3, the back cover 11 is positioned on a flat surface, and then turn the pages carefully while keeping a part of the face cover 10 that carries the socket elements 15 in parallel to the back cover 11. However, due to a big turn, the sheet members P that have been turned outwards from the back cover 11 toward the face cover 10 may return to their former position at the back cover 11 as indicated by the arrowhead sign A. When the number of the sheet members P that has been turned surpasses the number of the sheet members P that is rested on the back cover 11, the sheet members P that have been turned away from the back cover 11 to the face cover 10 impart a biasing force to the face cover 10 and the socket elements 15 against the stud elements 16, thereby causing a separation of the socket elements 15 from the stud elements 16.

Further, U.S. Pat. No. 6,663,310 discloses a button binder, which includes several buttons, connection pieces, pulling pieces, a front sheet, a rear sheet, and strips. A predetermined number of the buttons is affixed on the predetermined positions on the binder, such as on the left portion or top portion of the rear sheet. This design of button binder has the same drawback as the aforesaid snap binders. Therefore, this design of button binder can only be used to hold a small amount of papers or sheet members.

### SUMMARY OF THE INVENTION

The present invention has been accomplished to provide a paper binder, which eliminates the drawback of the aforesaid prior art designs. It is therefore-the main object of the present invention to provide a paper binder, which reduces the stretching force to the fasteners when the user opening the binder and, preventing reversing of the papers that have been opened. It is another object of the present invention to provide a paper binder, which is durable in use.

To achieve these and other objects of the present invention, the paper binder comprises a face cover; a back cover; a spine connected between the face cover and the back cover; a first hinge joining the face cover and the spine; a second hinge joining the back cover and the spine; a supplementary strip fastened to the back cover, the supplementary strip comprising a narrow elongated first side panel, a narrow elongated second side panel, a narrow elongated bottom panel connected between one long side of the first side panel and one long side of the second side panel to hold the first side panel and the second side panel in parallel, and a plurality of flaps respectively hinged to the second side panel and arranged in a line along the length of the second side panel, the bottom panel having a first long side hinged to the first side panel and a second long side hinged to the second side panel; and a plurality of fasteners installed in the supplementary strip for holding sheet members, the fasteners each comprising a male fastening member and a female fastening member respectively affixed to the first side panel and the flaps of the supplementary strip.

Further, the face cover, the back cover, the first hinge and the second hinge are made of polypropylene. The fibers of the polypropylene at the first hinge and the second hinge extend in a longitudinal direction in parallel to the length of the first hinge and the second hinge. The fibers of the polypropylene at the face cover and the back cover extend in a transverse direction perpendicular to the extending direction of the fibers of the polypropylene at the first hinge and the second hinge. Therefore, frequently opening and closing the paper binder does not cause the first hinge and the second hinge to break.

### BRIEF DESCRIPTION OF THE DRAWINGS

FIG. 1 is an extended view of a snap binder according to the prior art.

FIG. 2 shows the closed status of the snap binder according to the prior art.

FIG. 3 is a schematic sectional view showing a status of use of the snap binder according to the prior art.

FIG. 4 is a perspective view of a part of a paper binder (snap binder) according to the present invention, showing the structure of the supplementary strip and the positioning of the snaps in the supplementary strip.

FIG. 5 illustrates the extended status of the paper binder (snap binder) according to the present invention.

FIG. 6 is a schematic drawing showing the supplementary strip extended out and the snaps unfastened according to the present invention.

FIG. 7 is a schematic drawing showing the paper binder (snap binder) closed and a number of sheet members held in the snap binder according to the present invention.

FIG. 8 is a schematic drawing showing a small number of the sheet members opened with the face cover of the paper binder (snap binder) according to the present invention.

FIG. 9 is a schematic drawing showing a major part of the sheet members opened with the face cover of the paper binder (snap binder) according to the present invention.

FIG. 10 is a sectional view taken in an enlarged scale along line 10-10 of FIG. 7.

FIG. 11 is a sectional view taken in an enlarged scale along line 11-11 of FIG. 8.

FIG. 12 is a sectional view taken in an enlarged scale along line 12-12 of FIG. 9.

FIG. 13 is a schematic drawing showing the extending directions of the polypropylene fibers at different parts of the paper binder (snap binder) according to the present invention.

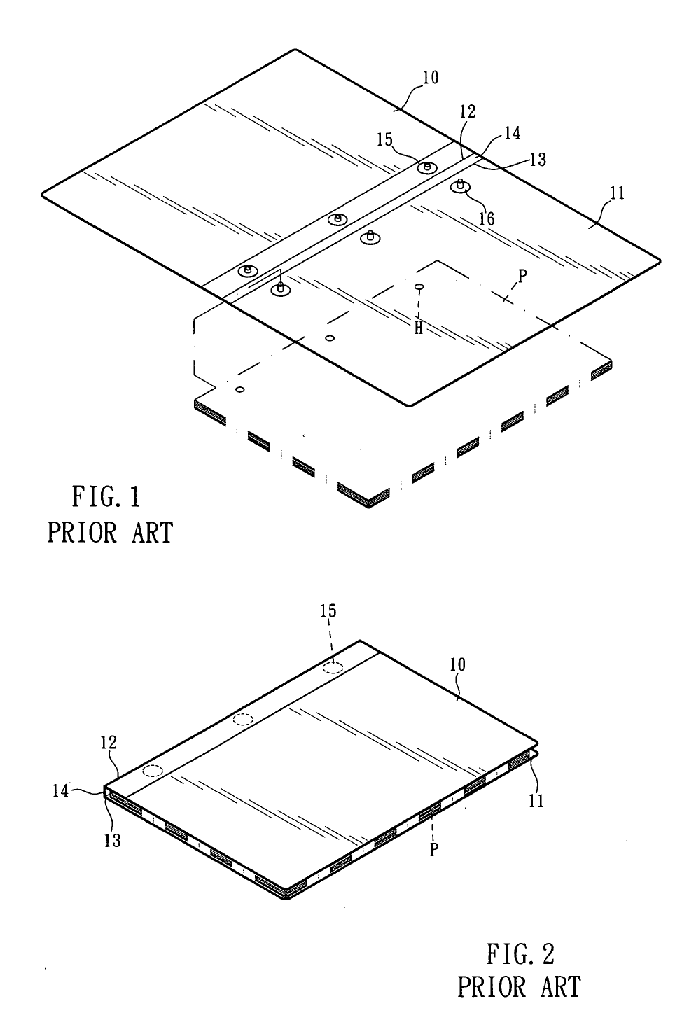

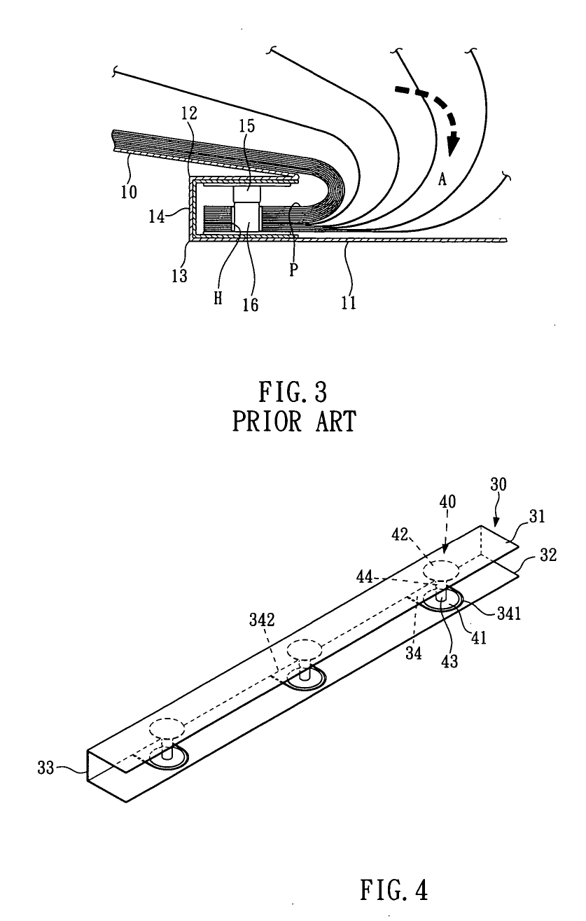

### DETAILED DESCRIPTION OF THE PREFERRED EMBODIMENT

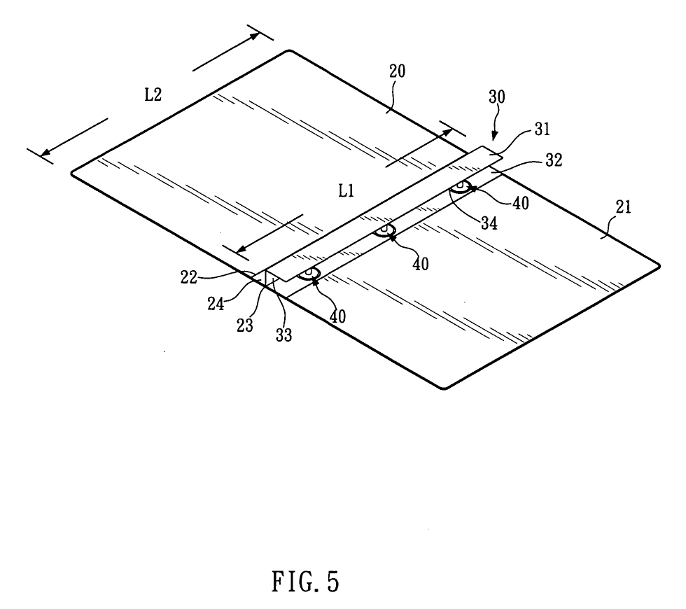

Referring to FIGS. 4 and 5, a paper binder (snap binder) in accordance with the present invention is shown comprising a face cover 20, a back cover 21, a spine 24 connected between the face cover 20 and the back cover 21, a first hinge 22 joining the face cover 20 and the spine 24, a second hinge 23 joining the back cover 21 and the spine 24, a supplementary strip 30 fastened to the back cover 21, and a plurality of snaps 40 installed in the supplementary strip 30.

The length L1 of the supplementary strip 30 is equal to the length L2 of the face cover 20 and the back cover 21. The supplementary strip 30 comprises a first side panel 31, a second side panel 32, a bottom panel 33 connected between one long side of the first side panel 31 and one long side of the second side panel 32 to hold the first side panel 31 and the second side panel 32 in parallel. The second side panel 32 has a plurality of openings 341 equally spaced along the length, and a plurality of flaps 34 respectively suspending in the openings 341. The flaps 34 each has a fixed end 342 hinged to the connection area between the second side panel 32 and the bottom panel 33. Preferably, the openings 341 have a semicircular shape. The flaps 34 are formed of a part of the second side panels 32 upon formation of the openings 341. The second side panel 32 is fixedly fastened to the back cover 21 along the second hinge 23, keeping the bottom panel 33 close to the spine 24 and the flaps 34 turnable away from the back cover 21.

The snaps 40 each are comprised of a stud side 41 having a stud (post) 43, and a socket side 42 having a socket 44. The stud side 41 is fixedly fastened to one flap 34. The socket side 42 is fixedly fastened to the first side panel 31 and aimed at the stud side 41.

The aforesaid face cover 20, back cover 21, supplementary strip 30 and snaps 40 are made of polypropylene (PP).

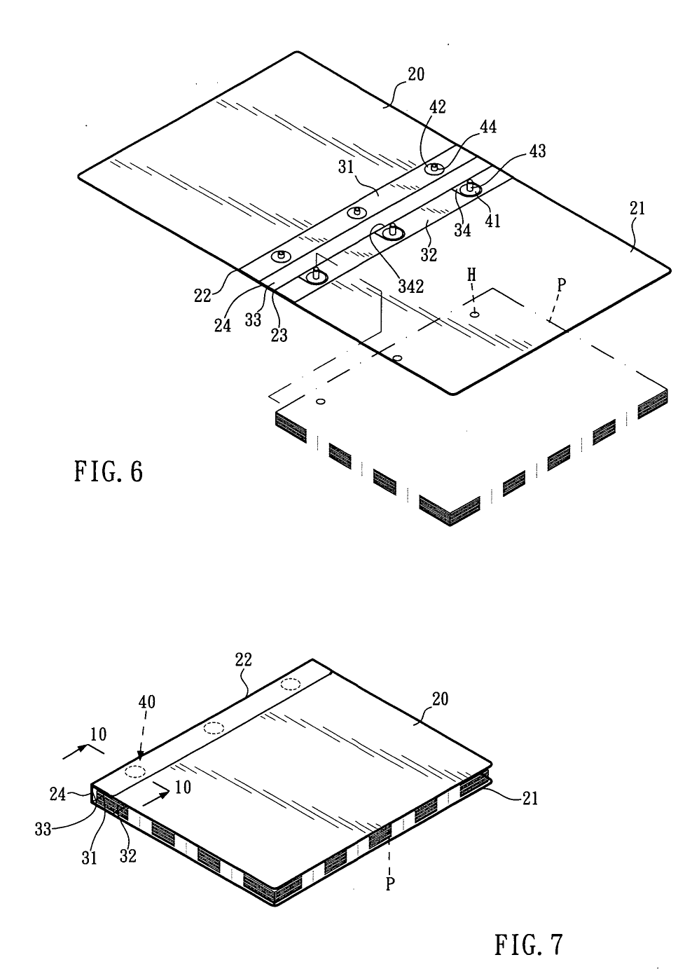

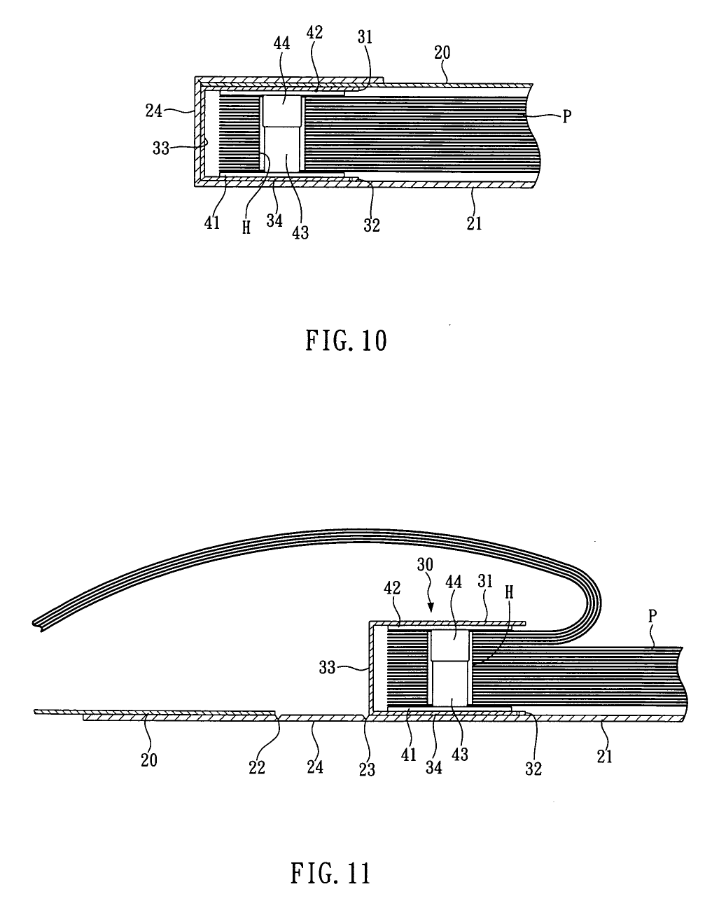

When in use, as shown in FIG. 6, the face cover 20 and the back cover 21 are extended out, and then the supplementary strip 30 is extended out to unfasten the snaps 40, and then the punch holes H of the sheet members P are respectively attached to the sockets 44 of the snaps 40, and then the face cover 20 is closed to force the respective studs 43 into engagement with the respective sockets 44 as shown in FIGS. 7 and 10.

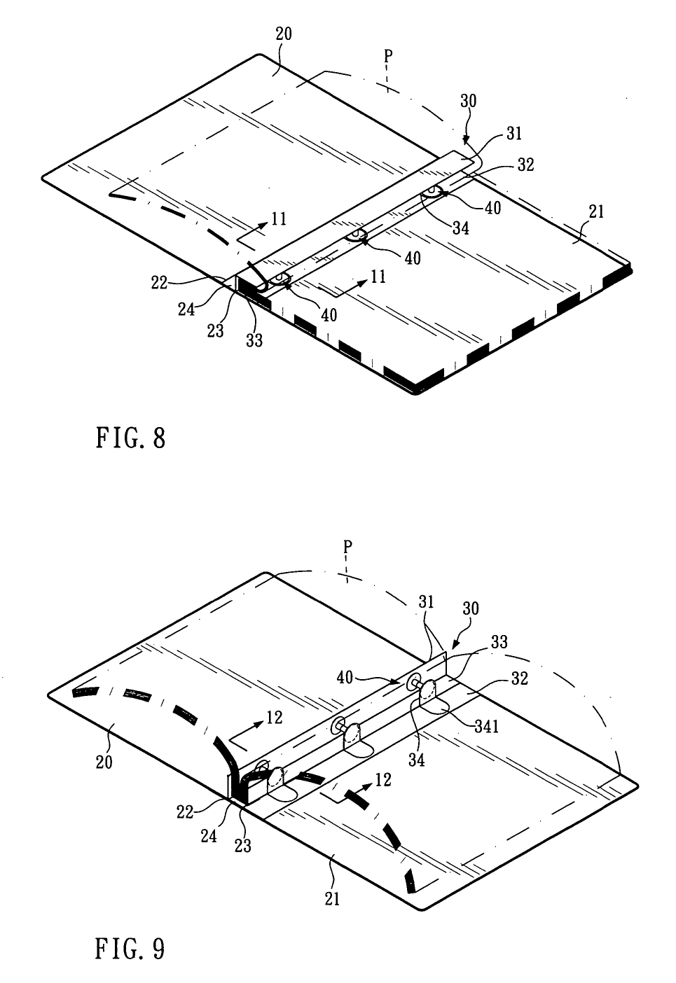

FIGS. 8 and 11 show the status that the face cover 20 and a small number of the sheet members P are opened; the first side panel 31 and the second side panel 32 are kept in parallel at different elevations; the sheet members P that have been opened are curved through a U-turn.

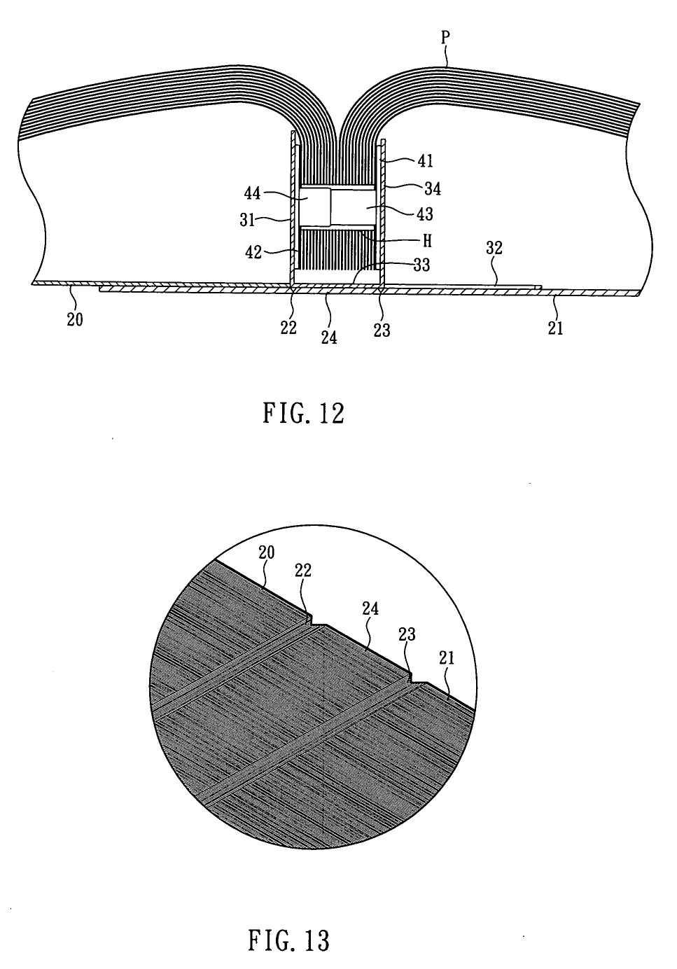

When more and more sheet members P have been opened as shown in FIGS. 9 and 12, the opened sheet members P impart an outward biasing force to the first side panel 31 of the supplementary strip 30 toward the face cover 20, thereby causing the snaps 40 to be moved with the first side panel 31 toward the face cover 20. At this time, the flaps 34 are turned with the snaps 40 and the first side panel 31 away from the second side panel 32 toward the face cover 20, keeping the stud side 41 and socket side 42 of each snap 40 fastened together.

As stated above, the face cover 20 and the back cover 21 are made of polypropylene (PP). FIG. 13 is an enlarged view of a part of the present invention, showing the extending directions of the polypropylene fibers at the face cover 20, the back cover 21 and the hinges 22 and 23. As illustrated, the polypropylene fibers at the hinges 22 and 23 extend in longitudinal direction, i.e., in parallel to the length of the hinges 22 and 23. The polypropylene fibers at the face cover 20 and the back cover 21 extend in transverse direction, i.e., perpendicular to the length of the hinges 22 and 23.

Although a particular embodiment of the invention has been described in detail for purposes of illustration, various modifications and enhancements may be made without departing from the spirit and scope of the invention.

What the invention claimed is:

1. A paper binder comprising;
a face cover;
a back cover;
a spine connected between said face cover and said back cover;
a first hinge joining said face cover and said spine;
a second hinge joining said back cover and said spine;
a supplementary strip fastened to said back cover, said supplementary strip comprising a narrow elongated first side panel, a narrow elongated second side panel, a narrow elongated bottom panel connected between one long side of said first side panel and one long side of said second side panel to hold said first side panel and said second side panel in parallel, and a plurality of flaps respectively hinged to said second side panel and arranged in a line along the length of said second side panel, said bottom panel having a first long side hinged to said first side panel and a second long side hinged to said second side panel; and
a plurality of fasteners installed in said supplementary strip for holding sheet members, said fasteners each comprising a male fastening member and a female fastening member respectively affixed to said first side panel and said flaps of said supplementary strip.

2. The paper binder as claimed in claim 1, wherein said fasteners are snaps each comprising a socket side and a stud side respectively affixed to said first side panel and said flaps of said supplementary strip, said socket side having a socket, said stud side having a stub connectable to the socket of said socket side.

3. The paper binder as claimed in claim 1, wherein said first side panel and said second side panel of said supplementary strip are kept in parallel when the male fastening members of said fasteners are fastened up with the respective female fastening members.

4. The paper binder as claimed in claim 1, wherein said supplementary strip has a length equal to the length of said face cover and said back cover.

5. The paper binder as claimed in claim 1, wherein said second side panel of said supplementary strip comprises a plurality of openings arranged in a line along the length of said supplementary strip; said flaps are respectively suspending in said openings.

6. The paper binder as claimed in claim 5, wherein said flaps each have a fixed end hinged to the connection area between said second side panel and said bottom panel.

7. The paper binder as claimed in claim 1, wherein said face cover, said back cover, said first hinge and said second hinge are respectively made of polypropylene.

8. The paper binder as claimed in claim 7, wherein said polypropylene has fibers arranged in said first hinge and said second hinge in a longitudinal direction in parallel to the length of said first hinge and said second hinge.

9. The paper binder as claimed in claim 8, wherein said polypropylene has fibers arranged in said face cover and said back cover in a transverse direction perpendicular to said longitudinal direction.

10. A paper binder comprising
a face cover;
a back cover;
a spine connected between said face cover and said back cover;
a first hinge joining said face cover and said spine;
a second hinge joining said back cover and said spine; and a binding structure installed in said back cover for holding papers;
wherein said binding structure comprises:
a supplementary strip fastened to said back cover, said supplementary strip comprising a narrow elongated first side panel, a narrow elongated second side panel, a narrow elongated bottom panel connected between one long side of said first side panel and one long side of said second side panel to hold said first side panel and said second side panel in parallel, and a plurality of flaps respectively hinged to said second side panel and arranged in a line along the length of said second side panel, said bottom panel having a first long side hinged to said first side panel and a second long side hinged to said second side panel; and
a plurality of fasteners installed in said supplementary strip for holding sheet members, said fasteners each comprising a male fastening member and a female fastening member respectively affixed to said first side panel and said flaps of said supplementary strip.

11. The paper binder as claimed in claim 10, wherein said fasteners are snaps each comprising a socket side and a stud side respectively affixed to said first side panel and said flaps of said supplementary strip, said socket side having a socket, said stud side having a stub connectable to the socket of said socket side.

12. The paper binder as claimed in claim 10, wherein said first side panel and said second side panel of said supplementary strip are kept in parallel when the male fastening members of said fasteners are fastened up with the respective female fastening members.

13. The paper binder as claimed in claim 10, wherein said second side panel of said supplementary strip comprises a plurality of openings arranged in a line along the length of said supplementary strip; said flaps are respectively suspending in said openings.

14. The paper binder as claimed in claim 13, wherein said flaps each have a fixed end hinged to the connection area between said second side panel and said bottom panel.
